(19) United States
(12) Patent Application Publication
(10) Pub. No.: US 2004/0197744 A1
(43) Pub. Date: Oct. 7, 2004

(54) Educational calendar

(76) Inventors: Roopa Basu, Richmond, VA (US); Jaideep Ganguly, Richmond, VA (US); Soumitra Banerjee, Richmond, VA (US)

Correspondence Address: CLARK & BRODY, 1750 K STREET NW, SUITE 600, WASHINGTON, DC, 20006, US

(21) Appl. No.: 10/790,815

(22) Filed: Mar. 3, 2004

Related U.S. Application Data
(60) Provisional application No. 60/450,649, filed on Mar. 3, 2003.

(51) Int. Cl. G09B 11/00

(52) U.S. Cl. 434/81

(57) ABSTRACT

An educational calendar includes a base having a display surface, and the display surface is divided into three areas. A first area has indicia of months of the year, a second area having an indicia of days of the week, and a third area having indicia of dates of a month. An arrangement of each of the months, days, and dates in each respective area is mutually unrelated to each other so that the location of a day of the week is unrelated to dates of the month. Borders or other identifiers are used to identify the month, day, and day.

This application claims priority under 35 USC 119(e) based on provisional patent application No. 60/450,649 filed on Mar. 3, 2003.

### FIELD OF THE INVENTION

The present invention is directed to an educational calendar and in particular, to a calendar which groups months, days of the week, and dates of the month in separate areas so that days and dates are not spatially related.

### BACKGROUND ART

In the prior art, a number of calendars have been developed to teach youngsters to better understand the concept of passing time. However, for younger children, it is sometimes difficult to understand the concept of associating a day of the week or date of a month with a particular location in a calendar.

Accordingly, a need exists to provide better calendar-teaching tools, ones that allow youngsters to better grasp the concept of time in the context of a calendar.

The present invention responds to this need by providing a calendar, which allows a youngster to identify months, days of the week, and dates in a month, but without the confusion caused by present day calendars.

### SUMMARY OF THE INVENTION

It is a first object of the present invention to provide an improved educational calendar.

Another object of the invention is to provide a method of using the improved educational calendar.

Yet another object of the invention is to provide a calendar employing magnetic means to aid in identifying calendar entries.

Other objects and advantages of the present invention will become apparent as a description thereof proceeds.

In satisfaction of the foregoing objects and advantages, the present invention provides an improved calendar for education purposes comprising a base having a display surface that is divided into three areas. A first area has indicia of months of the year, each indicia including the month and a decorative design indicia associated with each month, a second area having an indicia of days of the week, and a third area having indicia of dates of a month with the dates of the month are arranged in rows. Adjacent rows are offset from each other, and an arrangement of the respective areas is mutually unrelated to each other so that at least the location of a day of the week is unrelated spatially to dates of the month, the second area arranged between the first and third areas.

Means are provided to identify a particular calendar entry of a month, day of the week, and date of the month. One example of such means includes at least three borders, each movably mounted on the base so that each border can be moved to different locations on the display surface and can remain at a given location. Each border forms an opening that allows indicia on the display surface and indicia surrounded by the border to be seen. The borders are preferably held in place by a magnetic attraction with the base. Another example would entail the base as a touch screen, with the means for identifying comprising a touch area on the touch screen. Each touch area would have a touch spot for each of the months of the year, days of the week, and dates of a month.

The calendar can also include a clock for telling time, and a writing space on the surface of the base for making notes.

### BRIEF DESCRIPTION OF THE DRAWINGS

Reference is now made to the drawings of the invention wherein:

FIG. 1 is a top view of one embodiment of the invention; and

FIG. 2 is a top view of another embodiment of the invention.

### DESCRIPTION OF THE PREFERRED EMBODIMENTS

The inventive calendar is a learning device or toy for children, particularly children of 4 to 8 years of age. The inventive calendar enables children to associate date, days of the week, months, number of days in each month, and seasonal themes of the month. In one embodiment, the calendar comprises three parts: (1) a base, (2) a magnet-receptive surface in addition to or as part of the base, and optionally a write-erase capability, and (3) magnetic markers or borders to be located on the surface. The parts are described below in detail, with attention to materials that can be used, aesthetics, functionality, and shape and structure.

One reason why the inventive calendar is unique is because the dates, days, and months (with themes) are separate from one another, stationary in their place, and are not arranged in a correlated manner as in a conventional calendar (where the dates in a given month correspond to the day of the week).

For the inventive calendar, the following embodiments are also contemplated:

A calendar with a clock in it (to familiarize children with date, and time);

A calendar with a write-erase space for a ‘to-do list’;

A calendar with a ‘responsibility chart’ for daily tasks;

A calendar with a write-erase board on the back (and swivel on frame to enable easy switching between the calendar and writing board);

A calendar that plays music when markers are moved;

A calendar with talking feature where the date, day, and month are announced when markers are moved;

A calendar without magnet-attracting surface and markers without magnets, where the markers are located on the surface by any other means (mechanical means such as slots, pins, grooves, etc.; static electricity; suction cups, or similar types of attachments.)

A calendar without markers, where the dates, days, and months light up and glow when touched;

A calendar (electronic version) with an electronic touch-pad as the surface, and with features like announcing the date, playing music (every day/hour), and/or connecting to the internet for weather, news, etc.

A software version of the calendar, wherein the calendar can come up as a screen saver or background, or run as an application program on a computer.

It is believed that the different embodiments described above entail conventional technology such that a more detailed description is not necessary for understanding. For example, since touch screens, and screen savers and the like are well known, a further description of the details of producing the inventive calendar as a touch screen or as a display on a computer would not be needed for understanding of the invention.

Referring again to the principle embodiment of the invention, wherein the calendar comprises a base having a display surface with areas of dates, days, and months, the following addresses various aspects of the base, the base surface, and the markers.

Base

The calendar base can have a variety of constructions. For example, the base can be made of injection molded or fabricated plastic, machined or molded wood, acrylic, nylon, foam, or machined or stamped metal, or combinations thereof.

The base surface can have a matte or glossy finish, retaining the natural color of the material or the surface may be painted.

The areas of the base showing the dates, days, and months (with themes) can be printed on the surface in separate zones, in a vertical or horizontal arrangement. The surface can have a write-erase capability to accommodate areas where notes or other writing is memorialized. Graphics or other indicia can be associated with one or more of the calendar entries of days, dates, and months.

The calendar base can be designed to support the magnet-receptive surface, either simply by seating it, or by locating the magnet-receptive surface into a recess in the base.

The calendar base can have any geometrical shape, square, rectangular, or circular in shape, with straight or rounded corners, and no sharp edges. The base should be relatively rigid in structure and not flexible when twisted (by an 8 year old).

Base Surface

As described above, the surface of the base can be made so that magnetism is used for holding the markers or borders in a desired place. The magnet-receptive surface can be iron-impregnated rubber, vinyl, or paper, with a printable surface, and may have write-wipe capability. A steel sheet may also be used as the magnet-receptive surface.

The base surface will allow the magnetic markers or borders to adhere on to it (by magnetism), and moved around to match the date, day, and month.

The magnet-receptive surface can be square, rectangular, or circular in shape, and will either simply rest, or be glued or welded or pinned to the calendar base. In the calendar, it is preferred that this surface be accessible only from one side, the top, since there would be no need to use the backside of the calendar. While the base surface is described as a separable item from the base, the two could be one piece. For example, the base could be a plastic material with one surface impregnated with ferro-magnetic materials so that magnetic markers would adhere in locations of choice.

Borders/Markers

The borders or markers can be made of injection molded or fabricated plastic, machined or molded wood, acrylic, nylon, foam, or machined or stamped metal. The surfaces thereof can have a matte or glossy finish, retaining the natural color of the material or the surface may be painted. The markers will adhere onto the magnet-receptive surface, and be capable to moving around the whole surface (without scratching the surface) to ‘mark’ the date, day, and month. The markers can be of any geometric shape, with straight or rounded corners. The whole marker may be magnetic/magnetized, or may be fitted with magnets.

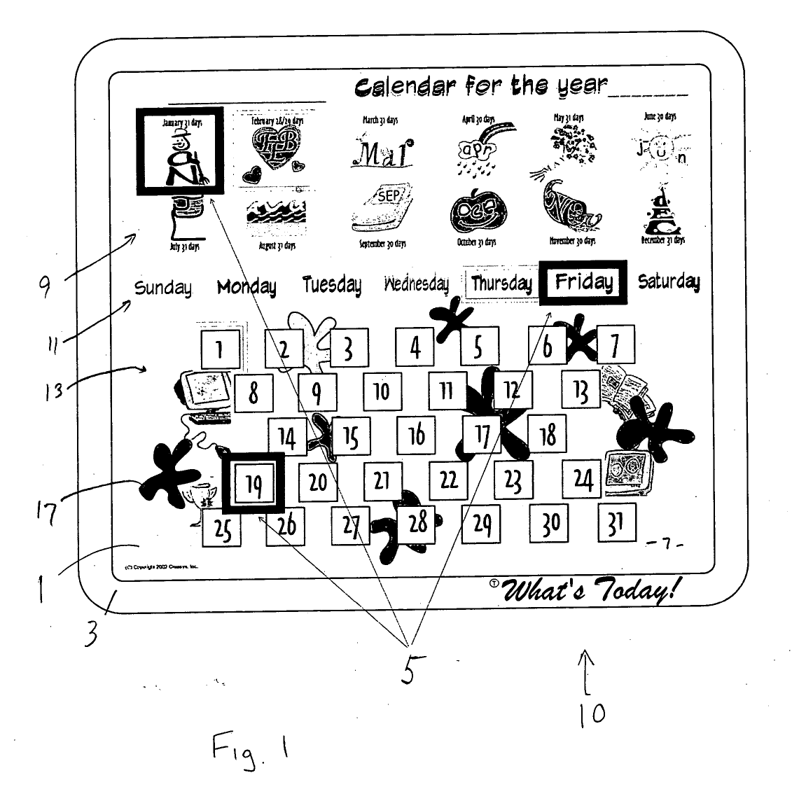

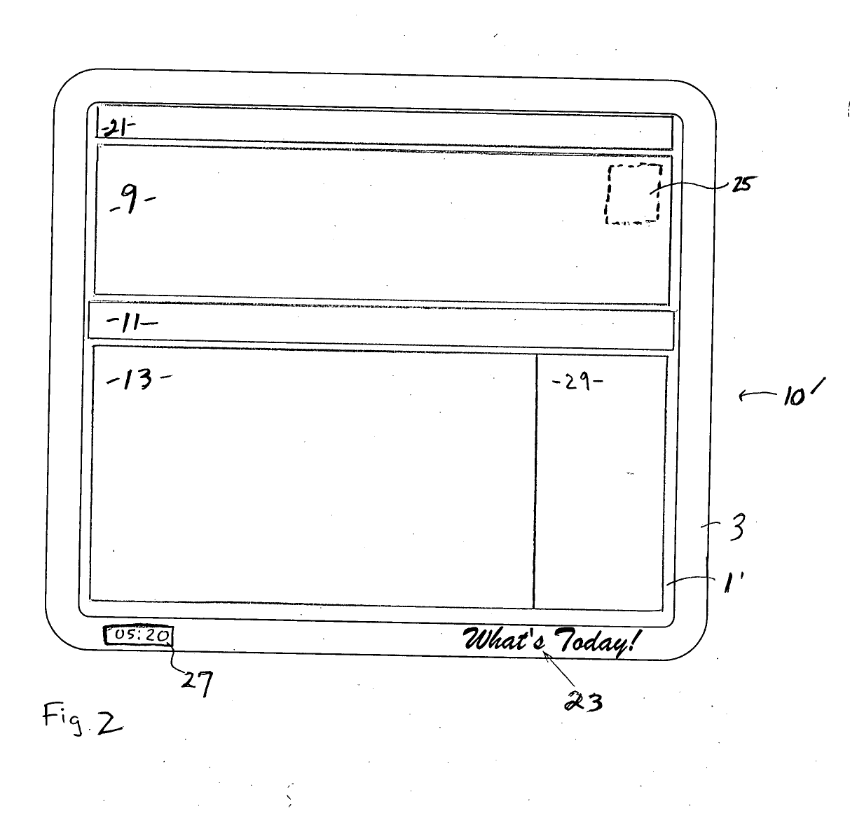

FIG. 1 shows one example of a calendar designated by the reference numeral 10, which includes a base 1, a base border 3, and markers or borders 5. The base has a surface 7, which is divided into three areas, 9, 11, and 13, see FIG. 2 for a more distinct view. The area 9 has indicia or graphics 15 showing the months and associated days. The days of the week are disposed in the horizontally aligned area 11 just below the area 9 having the months. Area 13 shows the days of the month with graphics 17 arranged amongst the days. As noted above, the locations of the areas 9, 11, and 13 could be changed if so desired.

In an exemplary use, each border 5 would be moved to a desired month, day of the week and date; e.g., one surrounding January, one surrounding the day of the week Friday, and one surrounding the day of the month “19”. For the next day, the border 5 surrounding Friday would be moved to Saturday, and the date border 5 surrounding “19” would be moved to “20”, and so on.

FIG. 2 shows another calendar 10′ similar to that depicted in FIG. 1 by having the areas 9, 11, and 13, but with a personalizing area 21. The personalizing area 21 could have a title as shown in FIG. 1, or be used as a note taking area with a dry erase marker or the like. While positioned above the month area 9, the area 21 could be positioned elsewhere on the base 10′.

The calendar 10′ also shows the use of a logo 23 that can be placed on the border 3, or elsewhere if so desired. Still referring to FIG. 2, the base 1′ can be made as a touch screen with touch pads 25, (only one illustrated) that would be positioned to coincide with each day of the week, month, and date. The touch pad 25 could be used in place of the borders shown in FIG. 1. Touching the pad 25 could illuminate the pad, generate a sound, produce an outline in place of the border or result in some other action that would identify the particular pad and day, date, and/or month that was selected. The touch pad 25 could also be used in combination with the border, wherein the border would still identify the selected day, date, and month, and the touch pad would provide a less permanent indicator, such as an audio sound of the actual selected parameter, e.g., generate the sound “Friday” to emphasize the selection of this day of the week. Since these touch pad/audio/light devices are well known in the art, a further description is not deemed necessary for understanding of the invention. A clock 27 can also be displayed as part of the calendar. Although a digital format clock is shown, any type any manner. FIG. 2 also shows an alternative note-taking area 29, which can be used for reminders, drawings, etc.

As such, an invention has been disclosed in terms of preferred embodiments thereof which fulfills each and every one of the objects of the present invention as set forth above and provides a new and improved educational calendar and method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. An improved calendar for education purposes comprising:
a base having a display surface, the display surface divided into three areas, a first area having an indicia of months of the year, each indicia including the month and a decorative design indicia associated with each month, a second area having an indicia of days of the week, and a third area having indicia of dates of a month, the dates of the month arranged in rows, with adjacent rows offset from each other, wherein an arrangement of the respective areas is mutually unrelated to each other so that at least the location of a day of the week is unrelated spatially to dates of the month, the second area arranged between the first and third areas;
at least three borders, each movably mounted on the base so that each border can be moved to different locations on the display surface and can remain at a given location, each border forming an opening that allows indicia on the display surface and surrounded by the border to be seen.

2. The calendar of claim 1, wherein the borders are magnetically held to the base.

3. The calendar of claim 1, wherein the days of the week in the second area are aligned horizontally.

4. The calendar of claim 1, further comprising a clock.

5. The calendar of claim 1, further comprising a fourth blank area for notation purposes.

6. An improved calendar for education purposes comprising
a base having a display surface, the display surface divided into three areas, a first area having an indicia of months of the year, each indicia including the month and a decorative design indicia associated with each month, a second area having an indicia of days of the week, and a third area having indicia of dates of a month, the dates of the month arranged in rows, with adjacent rows offset from each other, wherein an arrangement of the respective areas is mutually unrelated to each other so that at least the location of a day of the week is unrelated spatially to dates of the month, the second area arranged between the first and third areas;
means to identify a particular calendar entry of a month, day of the week, and date of the month.

7. The calendar of claim 6, wherein the identifying means are three magnetically held borders, each border having an opening to display one of the month, day or date.

8. The calendar of claim 6, wherein the base is a touch screen, and the means for identifying comprises a touch area on the touch screen, with each touch area having a touch spot for each of the months of the year, days of the week, and dates of the month.

9. The calendar of claim 6, further comprising a clock.

10. The calendar of claim 6, further comprising a fourth blank area for notation purposes.
